(19) United States
(12) Patent Application Publication
(10) Pub. No.: US 2012/0227657 A1
(43) Pub. Date: Sep. 13, 2012

(54) FLOATING FIRE ENCLOSURE

(76) Inventor: Robert BROCKWAY, Lake Clear, NY (US)

(21) Appl. No.: 13/412,707

(22) Filed: Mar. 6, 2012

Related U.S. Application Data
(60) Provisional application No. 61/450,712, filed on Mar. 9, 2011.

(51) Int. Cl. B63B 17/00; B23P 11/00; F24B 1/18

(52) U.S. Cl. 114/343; 29/426.2

(57) ABSTRACT

The invention relates to a floating fire enclosure, comprising a floating platform having an upper surface and an opening in the upper surface; and a fire enclosure fixed to said the floating platform, a method of making such a floating fire enclosure, and a method for supporting such a fire enclosure on a body of water.

### 1. CROSS-REFERENCE TO RELATED APPLICATIONS

This application claims the benefit of U.S. provisional patent application Ser. No. filed 61/450,712, filed Mar. 9, 2011, the entire disclosure of which is incorporated herein by reference.

### 1. FIELD OF INVENTION

The present invention generally relates to a raft or barge or other such floating structure that has a fire enclosure.

### 2. BACKGROUND OF THE INVENTION

Many different forms of fire pit exist, including ones that are based in the gardens of residential homes for the enjoyment of family barbeques, get-togethers and such like. Generally, these fire pits are fixed structures and people gather and sit outside around the fire. Due to the potential hazardous nature of fire, these fire pits are commonly built away from wooden structures so as to minimize the risk associated with ash.

Use of fire pits and barbeques peaks during the season of the year when the weather is warm and people wish to be outside. It is not uncommon, for example, to have a barbeque either at one's house or in a park or near a lake. To the best of Applicants' knowledge, there are no reports of any invention or object that enables one to combine the experience of floating on a lake with the enjoyment of sitting around a fire on land. There is a need in the art for an object that allows one to sit around a fire, while floating on a body of water.

### 3. SUMMARY OF THE INVENTION

The present invention addresses a need for people who seek to simultaneously enjoy the benefits of being near a fire (for example a fire pit) with the benefits of being on the water on a raft or other such floating structure.

The inventors of the present application perceived that there is a need in the marketplace for an invention that allows individuals, friends and family to gather and enjoy time together on a structure that floats on a lake or other body of water (e.g. a barge or raft) and at the same time be able to enjoy the atmosphere and possibilities that gathering around a fire on land offers.

Applicants have surprisingly discovered a method of making a floating raft, barge or other such floating structure, substantially made of wood, yet capable of having a fire on it for the enjoyment of those on board the floating raft. Such a floating fire enclosure is unique, addresses the need identified by the inventors and, as mentioned above, provides a safe means by which people can enjoy gathering around a fire while at the same time floating on a raft, barge or other such floating enclosure. A person of ordinary skill in the art, if anything, would have been motivated away from practicing the invention as presently taught.

In one embodiment, the present invention is directed to a floating fire enclosure, comprising: (a) a floating platform having an upper surface and an opening in the upper surface; and (b) a fire enclosure fixed to said floating platform. In an embodiment, the floating fire enclosure is made substantially of pressure-treated wood.

In one embodiment, the upper surface area of the floating platform is about 100 square feet, about 150 square feet, about 200 square feet, about 250 square feet, about 300 square feet, about 350 square feet, about 400 square feet, about 450 square feet, or about 500 square feet. In another embodiment, the area of the upper surface of the floating platform is about 300 square feet. In another embodiment, the area of the upper surface of the floating platform is from about 100 to about 600 square feet. In another embodiment, the area of the upper surface of the floating platform is from about 100 to about 400 square feet. In another embodiment, the area of the upper surface of the floating platform is from about 100 to about 250 square feet. In another embodiment, the area of the upper surface of the floating platform is from about 50 to about 200 square feet.

In one embodiment, the floating fire enclosure has an opening in the upper surface of the floating platform, and this opening in the upper surface does not connect with any part of the outer circumference of said floating platform. In another embodiment, the location of the opening in the upper surface of the floating platform is approximately in the middle of the floating platform.

In one embodiment, the floating platform further comprises a lower surface with an opening in said lower surface. In another embodiment, the floating fire enclosure further comprises floatation foam. Floatation foam is used to provide buoyancy, such as to enable the fire enclosure to float. Buoyancy billets were used in the present invention to float the fire enclosure. A skilled artisan would appreciate the various types of floatation foams that could be used, for example, Styrofoam Buoyancy Foam which is an extruded polystyrene insulation. Buoyancy Billets are durable. For example, it takes only one cubic foot of Styrofoam® brand buoyancy billets to float about 55 pounds.

In one embodiment, the floating platform of the floating fire enclosure further comprises a lower surface and said lower surface has an opening, wherein the distance between the upper surface and lower surface of the floating platform is the height of the platform and said opening is a void spanning the entire height of said platform. In one embodiment, the opening on the upper surface of the platform extends to the lower surface of the platform. In another embodiment, the circumference of the opening on the upper surface of the floating platform is substantially the same as the circumference of the opening on the lower surface of the floating platform.

In one embodiment, the area of the opening on the upper surface of the floating platform is from about 1% to about 10% of the area of the entire upper surface of the floating platform. In one embodiment, the area of the opening on the upper surface of the floating platform is from about 5% to about 15% of the area of the entire upper surface of the floating platform. In one embodiment, the area of the opening on the upper surface of the floating platform is from about 10% to about 20% of the area of the entire upper surface of the floating platform. In one embodiment, the area of the opening on the upper surface of the floating platform is from about 20% to about 40% of the area of the entire upper surface. In one embodiment, the area of the opening on the upper surface of the floating platform is about 15% of the area of the entire upper surface. In one embodiment, the area of the opening on the upper surface of the floating platform is about 5%, 8%, 11%, 14%, 17%, 20%, 23%, 26%, or 29% of the area of the entire upper surface.

In one embodiment, the fire enclosure comprises iron, aluminum, or other metallic element. In one embodiment, the floating fire enclosure accommodates up to 3200 kilograms on the floating platform. In another embodiment, the floating fire enclosure is designed to accommodate up to 30 people. The size of the floating fire enclosure can vary to and be commensurate with the demand. For example, a fire enclosure as presently taught can be designed on a smaller scale, wherein the floating platform can accommodate up to six people.

One aspect of the presently taught invention is directed to a floating fire enclosure, comprising (a) a floating platform having an upper surface; (b) an opening in said upper surface; (c) at least one support structure spanning at least a portion of said opening; and (d) a fire enclosure positioned on said support structure. In an embodiment, the floating fire enclosure is made substantially of pressure-treated wood. In one embodiment, the opening in the upper surface of the floating platform does not connect with any part of the outer circumference of the floating platform. In one embodiment, the location of the opening in the upper surface of the floating platform is in the middle or near the middle of the floating platform.

In one embodiment, the lower surface has an opening, wherein the distance between the upper surface and lower surface of the floating platform is the height of the platform and said opening is a void spanning the entire height of said platform. In another embodiment, the opening on the upper surface of the platform extends to the lower surface of the platform. In another embodiment, the circumference of the opening on the upper surface of said platform is substantially the same as the circumference of the opening on the lower surface of said platform. In another embodiment, the area of the opening in the upper surface of the floating platform is up to 40% of the area of the entire upper surface. In one embodiment, the support structure is made from iron, metal or aluminum. In another embodiment, the floating fire enclosure of the present invention accommodates up to 3200 kilograms on it.

One aspect of the present invention is directed to a method for making the presently taught floating fire enclosure. In particular, Applicants have discovered a method of making a floating fire enclosure, comprising: (a) providing a floating platform, wherein said floating platform has an upper and a lower surface; (b) removing a portion of the upper surface of said floating platform to reveal an opening; (c) attaching at least one support structure spanning at least a portion of said opening; and (d) positioning a fire enclosure on said support structure.

In one embodiment of the presently taught method, up to 40% of the upper surface is removed. In one embodiment, about 5% to about 15% of the area of the entire upper surface of the floating platform is removed. In one embodiment, about 10% to about 20% of the area of the entire upper surface of the floating platform is removed. In one embodiment, about 20% to about 40% of the area of the entire upper surface of the floating platform is removed. In one embodiment, about 5%, 8%, 11%, 14%, 17%, 20%, 23%, 26%, or about 29% of the area of the entire upper surface of the floating platform is removed.

In one embodiment, the support structure is iron or an iron substitute and is fixed to at least a portion of the opening on the floating platform. In another embodiment of the presently taught method, the support structure is positioned, mounted, attached, clipped, or fixed over at least a portion of the opening on the floating platform. In one embodiment of the presently taught method, the positioning step includes mounting, fixing, attaching or clipping the support structure on said fire enclosure. In one embodiment, the presently taught method further comprises the step of adding floatation foam to the floating fire enclosure.

One aspect of the present invention is directed to a method for supporting a fire enclosure on a body of water, comprising: inserting a floating platform having an upper surface with an opening thereon into a body of water, wherein at least one support structure spans at least a portion of the opening on the upper surface of said floating platform.

### 4. BRIEF DESCRIPTION OF THE DRAWINGS

FIG. 1 is a perspective view of one embodiment of the floating fire enclosure, in accordance with an aspect of the invention;

FIG. 1a is a partial broken away perspective view of the fire enclosure of the floating fire enclosure of FIG. 1, in accordance with an aspect of the invention;

FIG. 2 is a top view of the floating fire enclosure of FIG. 1, in accordance with an aspect of the invention;

FIG. 3 is a side view of the floating fire enclosure of FIG. 1, in accordance with an aspect of the invention;

FIG. 4 is a cross-sectional side view of the floating fire enclosure of FIG. 2, taken along line 4-4, in accordance with an aspect of the invention;

FIG. 5 is a cross-sectional side view of the floating fire enclosure of FIG. 2, taken along line 5-5, in accordance with an aspect of the invention;

FIG. 6 is a detailed cross-sectional side view of the fire enclosure of the floating fire enclosure of FIG. 4, in accordance with an aspect of the invention;

FIG. 7 is a detailed cross-sectional side view of the fire enclosure of the floating fire enclosure of FIG. 5, in accordance with an aspect of the invention;

FIG. 8 is a flow chart outlining the steps of making a floating fire enclosure, in accordance with an aspect of the invention.

### 5. DETAILED DESCRIPTION OF THE INVENTION

It is to be understood that the terminology used herein is for the purpose of describing particular embodiments only and is not intended to limit the scope of the present invention which will be limited only by the appended claims. Unless defined otherwise, all technical and scientific terms used herein have the same meanings as commonly understood by one of ordinary skill in the art to which this invention belongs.

As used herein, the term “floating platform” should be understood to include rafts, barges, vessels, platforms, docks or any other similar floating structure. In various embodiments the floating fire enclosure of the present invention may be removably or permanently attached to another floating structure or land. In another embodiment, the floating fire enclosure may be configured to be placed into and withdrawn from a body of water repeatedly. In another embodiment, the floating fire enclosure may be configured to be placed and maintained in a body of water.

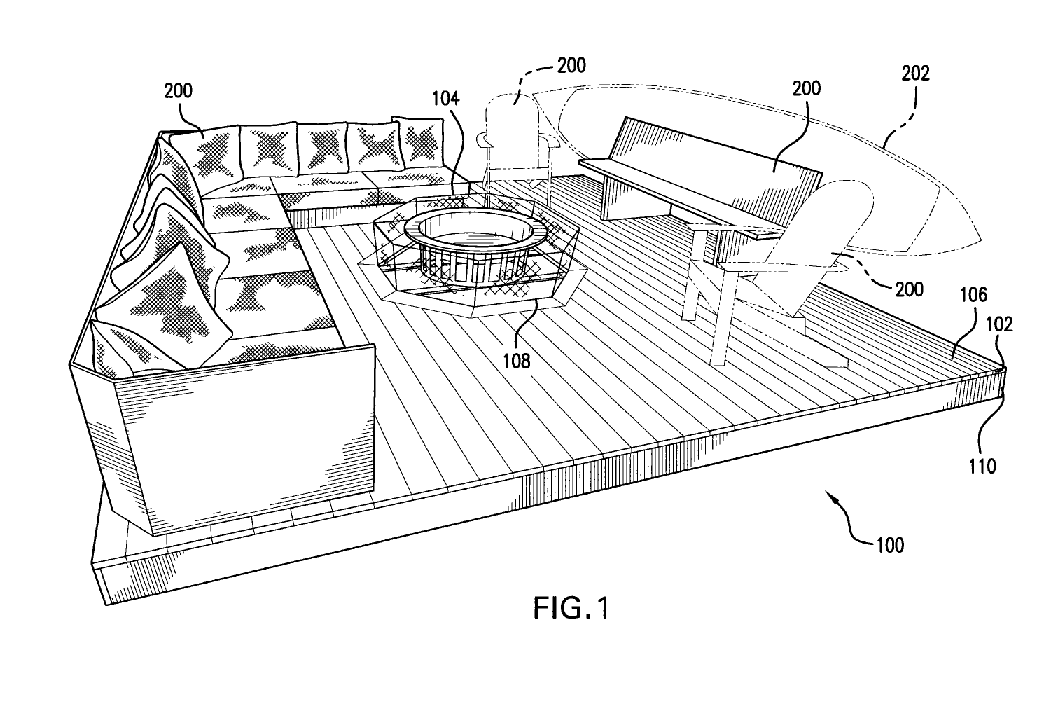

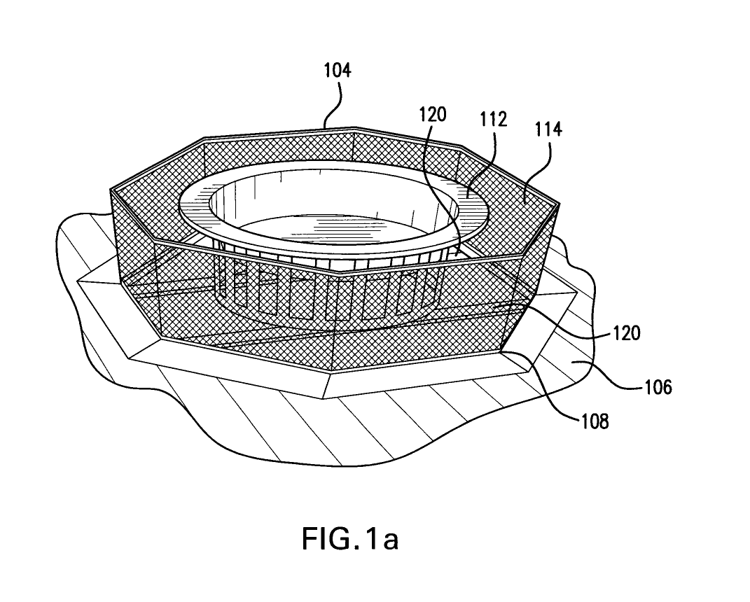

Referring to FIG. 1, the floating fire enclosure 100 of the present invention is shown, comprising a floating platform 102, and a fire enclosure 104. Floating platform 102 comprises an upper surface 106, an opening 108 formed in upper surface 106, and an outer circumference 110. Opening 108 formed in the upper surface 106 does not connect or intersect with outer circumference 110. Thus, opening 108 is bordered on all sides by upper surface 106. As shown in FIG. 1, opening 108 may be located substantially in the center of floating fire enclosure 100. In alternative embodiments, opening 108 may be located substantially off center. For example purposes, opening 108 may be located toward one side or in one corner of floating fire enclosure 100. Although various locations for opening 108 are contemplated, opening 108 is contained entirely within floating platform 102 and is fully supported thereby.

In various embodiments the area of the floating platform 102 may range from about 100 to about 600 square feet, about 100 to about 400 square feet, about 100 to about 250 square feet, or about 50 feet to about 200 square feet. In alternative embodiments, the area of the floating platform may be about 100 square feet, about 150 square feet, about 200 square feet, about 250 square feet, about 300 square feet, about 350 square feet, about 400 square feet, about 450 square feet, or about 500 square feet. The size of floating platform 102 may vary to accommodate a different number of people or alternatively, a different amount of equipment. For example purposes, floating platform 102 may be sized to accommodate 6 or fewer people or may be sized to accommodate 30 or more people. Floating platform 102 may also be sized to accommodate between 6 and 30 people. In various other embodiments, floating platform 102 may be configured to accommodate 8, 12, 16, 20, 24, or 27 people. In addition, floating platform 102 may be modular and attached to other floating platforms that may or may not also include a fire enclosure. In one embodiment, floating fire enclosure 100 accommodates up to 3200 kilograms on floating platform 102. In another embodiment, floating fire enclosure 100 is configured to support from about 50 kilograms to about 5000 kilograms. In various embodiments, floating fire enclosure is capable of supporting about 100 kilograms, about 1000 kilograms, about 1500 kilograms, about 2000 kilograms, about 2500 kilograms, about 3000 kilograms, about 3500 kilograms, about 4000 kilograms, or about 4500 kilograms.

The size of opening 108 in upper surface 106 may vary depending on the size of the floating fire enclosure 100. In various embodiments, the area of opening 108 may range from about 1% to about 10%, about 5% to about 15%, about 10% to about 20%, or about 20% to about 40%, of the area of upper surface 106 of floating platform 102. In one embodiment, the area of opening 108 on the upper surface of the floating platform is about 15% of the area of the entire upper surface. In other various embodiments, the area of opening 108 on the upper surface of the floating platform is about 5%, 8%, 11%, 14%, 17%, 20%, 23%, 26%, or 29% of the area of the entire upper surface.

Although floating fire enclosure 100 is shown as generally square in FIGS. 1-7, various embodiments may have other shapes. Example alternative shapes for floating fire enclosure 100 include, but are not limited to, rectangular, circular, octagonal, polygonal, oval or irregular.

As shown in FIG. 1a, fire enclosure 104 includes a burn pit 112, a fire guard 114 and a connecting section 116. In various embodiments, burn pit 112 may be of varied shapes and sizes, depending on the aesthetic desires and needs of the user. In still other embodiments, burn pit 112 may also be configured in varying shapes and sizes based on the overall dimensions of the floating fire enclosure 100. Burn pit 112 is suitable for containing wood, charcoal or other solid substances that burn and produce ash. Burn pit 112 is configured to withstand high temperatures without destruction, as well as retain ash and other byproducts of the fire. In alternative embodiments, burn pit 112 is configured to receive and retain or include a gas fireplace, electric fireplace or other known type of fireplace or fireplace alternative.

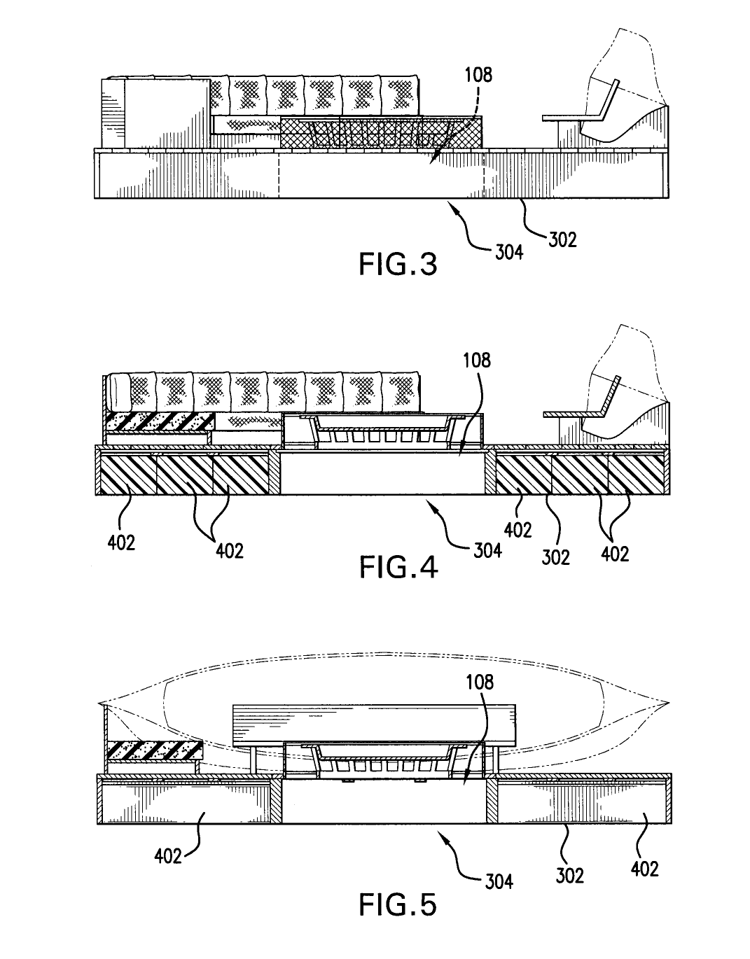

In any of the various embodiments, fire guard 114 may be provided to prevent the fire or sparks from the fire travelling from the burn pit 112 onto floating platform 102. Fire guard 114 may be solid metal, a mesh, or a screen. Connecting section 116 is provided to connect the fire guard 114 to the floating platform 102, and more specifically to upper surface 106. In at least one embodiment, connecting section 116 is a piece of metal, plastic, wood or other material which surrounds opening 108 and connects fire enclosure 104 to floating platform 102. In addition connecting section 116 may be aesthetically pleasing. Connecting section 116 may also be raised; if a user of floating fire enclosure 100 steps on connecting section 116, they may be aware that they are close to the fire. Also shown in FIG. 1a, are one or more support structures 120, which may support burn pit 112. One or more support structures 120 may be permanently or removably affixed to the floating fire enclosure 100. In various embodiments, one or more support structures 120 may be affixed to the underside of upper surface 106 or to a lower surface 302 (shown in FIG. 3). Burn pit 112 may be permanently affixed to one or more support structures 120. Alternatively, burn pit 112 may be removably affixed to one or more support structures 120 with one or more clips, clamps, ties, bolts, flanges, hinges, screws, or other means of removably affixing known in the art. One or more support structures 120 are designed to support the weight of fire enclosure 104.

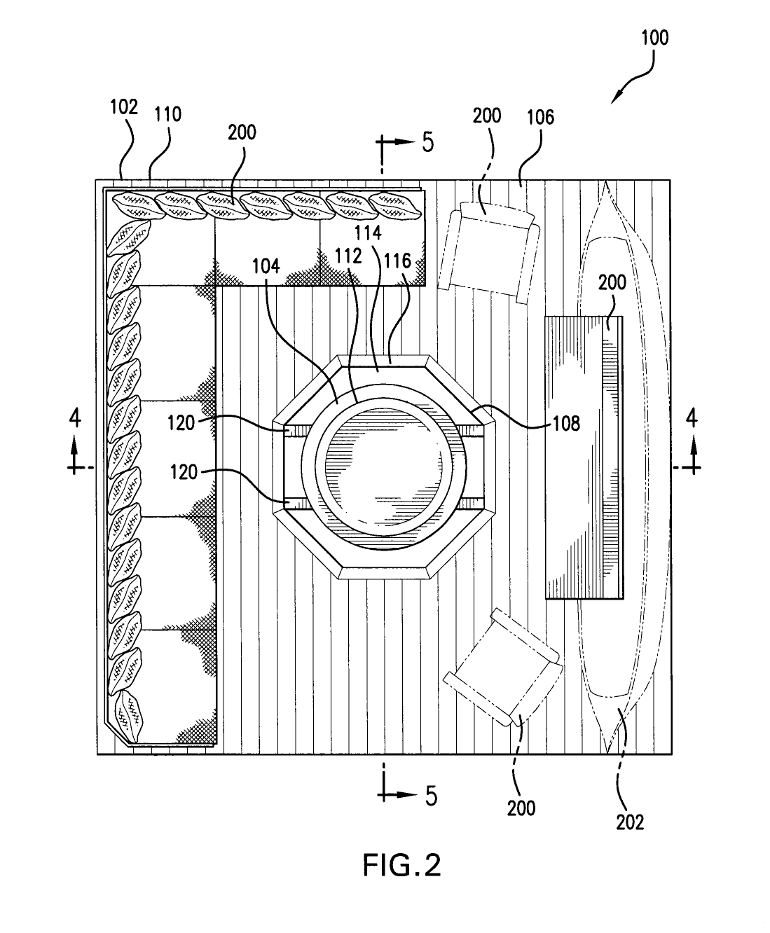

Referring now to FIG. 2, a top view of the floating fire enclosure 100 of FIG. 1 is shown. As shown in FIGS. 1 and 2, dock furniture 200 may be affixed to or removably placed on floating fire enclosure 100. A boat 202 and other equipment commonly used in aquatic activities may be placed on floating fire enclosure 100.

As shown in FIGS. 3, 4, and 5, floating fire enclosure 100 may include a lower surface 302. An opening 304 may be formed in the lower surface substantially inferior to opening 108 formed in the upper surface. In various embodiments, a passage or void may be present between opening 108 and opening 304. In traditional land based fire pits, the fire pit is often surrounded by cement, concrete, or another material which is fire proof and capable or dissipating heat from the fire. However, in the floating fire enclosure 100, the passage or void between opening 108 and opening 304 allows the heat from the fire and burn pit 112 to be dissipated by the body of water and/or air beneath floating fire enclosure 100. Wood, charcoal, other flammable material or gas fireplace is located within burn pit 112. Ash, coals, and other byproducts that are not entirely consumed by the fire are caught and retained by burn pit 112.

A floatation foam 402 is provided between upper surface 106 and lower surface 302. The flotation foam 402 should be sufficiently buoyant to support floating fire pit 100 as well as users, equipment and furniture that may be placed on the floating fire enclosure 100. For example purposes, floatation foam 402 includes flotation foam, STYROFOAM®, extruded polystyrene, buoyancy billets, other types of foam commonly used for flotation, balsa wood, and other materials known for floatation. Floatation foam 402 that resists heat, dissipates heat, and the structural integrity of which is not compromised by heat is preferred, as the flotation foam 402 may be affected by the heat from burn pit 112. An additional preferred characteristic of the flotation foam 402 is the ability to resist fire or to remain buoyant after exposure to fire.

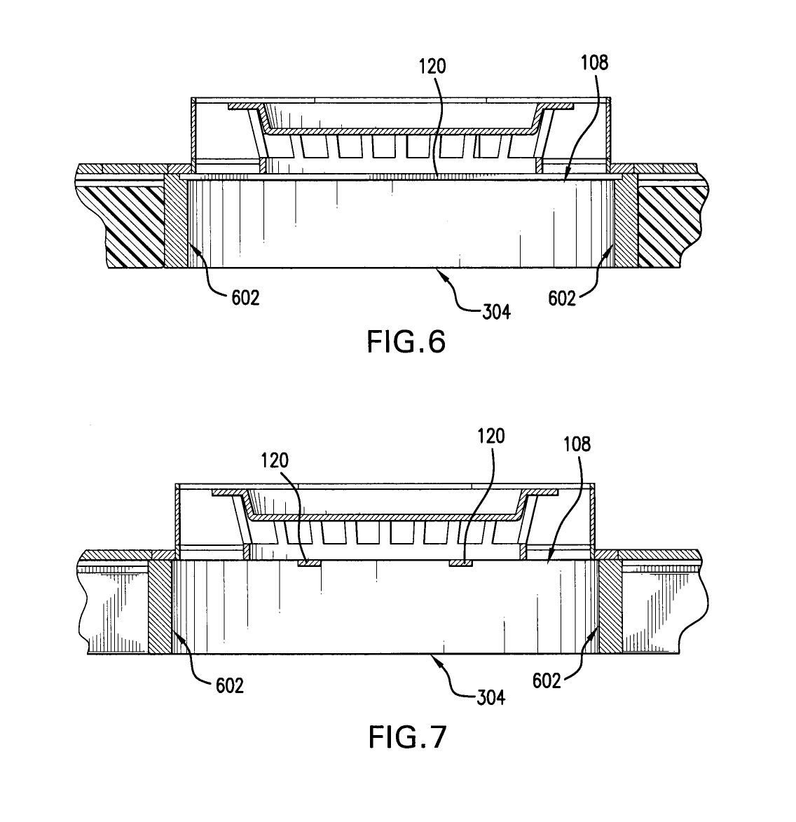

Referring now to FIGS. 6 and 7, the circumference of the opening 108 in the upper surface is substantially the same as the circumference of the opening 304 in the lower surface. The area of the opening 108 in the upper surface is substantially the same as the area of the opening 304 in the lower surface. Also shown in FIGS. 6 and 7, a protective surface 602 may be formed on the passage between opening in the upper surface and the opening in the lower surface. Protective surface 602 may simply be wood that has been treated with or covered by a heat and/or fire resistant covering. Alternatively, protective surface 602 may be wood covered by a metal plate such as steel, aluminum or other metal suitable for protecting the wood and insulating material from heat and fire.

The embodiments depicted in FIGS. 1-7 show burn pit 112 generally superior to the upper surface 106. However, burn pit 112 may be located inferior to the floating platform 102 such that it is within the floating platform 102. In this embodiment, it is essential that the floating platform 102 is shielded from the heat and flame of the burn pit 112 with a fire proof material such as metal.

In another alternative embodiment, floating fire enclosure 100 includes a cover (not pictured) which covers opening 108 in upper surface 106. The cover may be comprised of metal, wood or other material. Thus, opening 108 may be covered and protected from the elements when burn pit 112 is not in use. Additionally, the cover will prevent people and accidental debris from entering the burn pit 112. In other alternative embodiments, the cover may be configured as a table or other piece of furniture such that it may be used for an alternative purpose when fire pit 112 is not in use. The cover is substantially the same size as opening 108. Thus, in various embodiments, the area of the cover may range from about 1% to about 10%, about 5% to about 15%, about 10% to about 20%, or about 20% to about 40%, of the area of the entire upper surface 106 of the floating platform. In one embodiment, the area of the cover on the upper surface 106 of the floating platform is about 15% of the area of the entire upper surface 106. In other various embodiments, the area of the cover on the upper surface 106 of the floating platform is about 5%, 8%, 11%, 14%, 17%, 20%, 23%, 26%, or 29% of the area of the entire upper surface 106.

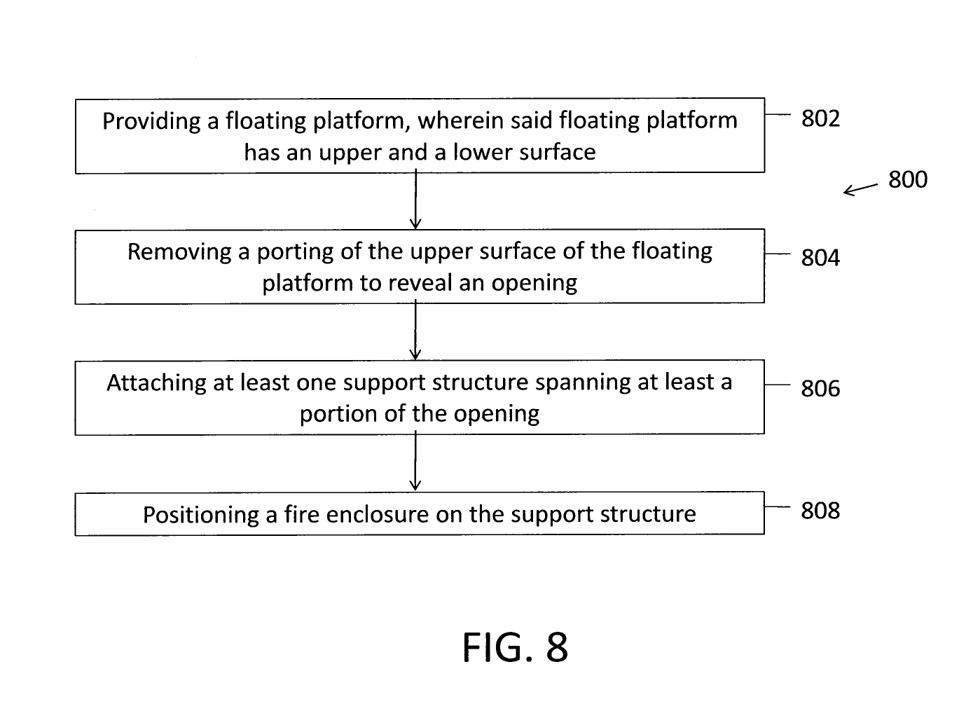

Referring now to FIG. 8, a method of making a floating fire enclosure 800 may be comprised of the steps of providing a floating platform, where the platform has an upper and a lower surface 802, removing a portion of the upper surface of the floating platform to reveal an opening 804, attaching at least one support structure spanning at least a portion of the opening 806 and positioning a fire enclosure on the support structure 808. The portion of the upper surface that is removed may be 40% of the top surface by area. The support structure included in the floating fire enclosure may be comprised or iron, or an iron substitute, such as another metal, or other fire proof material. The step of positioning the fire enclosure on the support structure may include mounting, affixing, clipping, bolting, screwing, or otherwise permanently or removably attaching the fire enclosure on the support structure. The method may further comprise the step of adding floatation foam or an alternative floatation material to the floating fire enclosure. The floatation foam or flotation material is placed between the upper surface and the lower surface.

An additional step that may be included in the method is the step of removing a portion of the floating platform 102 or a portion of the upper surface 106 of the floating platform 102 to create opening 108 in the upper surface. In various embodiments of the method, the portion of floating platform 102 or the upper surface 106 of the floating platform may range from about 1% to about 10%, about 5% to about 15%, about 10% to about 20%, or about 20% to about 40%, of the area of the entire upper surface 106 of the floating platform 102. In one embodiment, the portion removed from the floating platform 102 or upper surface 106 may be about 15% of the area of the entire upper surface. In other various embodiments, the portion of the floating platform 102 or upper surface 108 may be about 5%, 8%, 11%, 14%, 17%, 20%, 23%, 26%, or 29% of the area of the entire upper surface.

Also provided is a method of supporting a fire enclosure on a body of water, including the step of inserting a floating platform having an upper surface with an opening thereon into a body of water where at least one support structure spans at least a portion of the opening on the upper surface of the floating platform.

All publications, patents, and patent applications mentioned herein are hereby incorporated by reference in their entirety as if each individual publication or patent was specifically and individually indicated to be incorporated by reference. In case of conflict, the present application, including any definitions herein, will control. While several aspects of the present invention have been described and depicted herein, alternative aspects may be effected by those skilled in the art to accomplish the same objectives. Those skilled in the art will recognize, or be able to ascertain using no more than routine experimentation, many equivalents to the specific embodiments of the invention described herein. Accordingly, it is intended by the appended claims to cover all such alternative aspects as fall within the true spirit and scope of the invention.

What is claimed is:

1. A floating fire enclosure, comprising:
(a) a floating platform having an upper surface and an opening in the upper surface; and
(b) a fire enclosure fixed to said floating platform.

2. The floating fire enclosure of claim 1, wherein said enclosure is made substantially of pressure-treated wood.

3. The floating fire enclosure of claim 1, wherein the upper surface area of said floating platform is about 100 square feet, about 150 square feet, about 200 square feet, about 250 square feet, about 300 square feet, about 350 square feet, about 400 square feet, about 450 square feet, or about 500 square feet.

4. The floating fire enclosure of claim 1, wherein the area of the upper surface of said floating platform is about 300 square feet.

5. The floating fire enclosure of claim 1, wherein the opening in the upper surface of said floating platform does not connect with any part of the outer circumference of said floating platform.

6. The floating fire enclosure of claim 1, wherein the location of the opening in the upper surface of said floating platform is approximately in the middle of the floating platform.

7. The floating fire enclosure of claim 1, wherein said floating platform further comprises a lower surface with an opening in said lower surface.

8. The floating fire enclosure of claim 1, further comprising floatation foam.

9. The floating fire enclosure of claim 1, wherein said floating platform further comprises a lower surface and said lower surface has an opening, wherein the distance between the upper surface and lower surface of the floating platform is the height of the platform and said opening is a void spanning the entire height of said platform.

10. The floating fire enclosure of claim 7, wherein the opening on the upper surface of the platform extends to the lower surface of the platform.

11. The floating fire enclosure of claim 7, wherein the circumference of the opening on the upper surface of said platform is substantially the same as the circumference of the opening on the lower surface of said platform.

12. The floating fire enclosure of claim 1, wherein the area of said opening in the upper surface of said platform is from about 1% to 10% of the area of the entire upper surface.

13. The floating fire enclosure of claim 1, wherein the area of said opening in the upper surface of said platform is from about 5% to 15% of the area of the entire upper surface.

14. The floating fire enclosure of claim 1, wherein the area of said opening in the upper surface of said platform is from about 10% to 20% of the area of the entire upper surface.

15. The floating fire enclosure of claim 1, wherein the area of said opening in the upper surface of said platform is from about 20% to 40% of the area of the entire upper surface.

16. The floating fire enclosure of claim 1, wherein said fire enclosure comprises metal or aluminum.

17. The floating fire enclosure of claim 1, wherein said enclosure accommodates up to 3200 kilograms on it.

18. A floating fire enclosure, comprising:
(a) a floating platform having an upper surface;
(b) an opening in said upper surface;
(c) at least one support structure spanning at least a portion of said opening; and
(d) a fire enclosure positioned on said support structure.

19. The floating fire enclosure of claim 18, wherein said enclosure is made substantially of pressure treated wood.

20. The floating fire enclosure of claim 18, wherein the upper surface area of said floating platform is about 100 square feet, about 150 square feet, about 200 square feet, about 250 square feet, about 300 square feet, about 350 square feet, about 400 square feet, about 450 square feet, or about 500 square feet.

21. The floating fire enclosure of claim 18, wherein the area of the upper surface of said floating platform is about 300 square feet.

22. The floating fire enclosure of claim 18, wherein the opening in the upper surface of said floating platform does not connect with any part of the outer circumference of said floating platform.

23. The floating fire enclosure of claim 18, wherein the location of the opening in the upper surface of said floating platform is in the middle or near the middle of the floating platform.

24. The floating fire enclosure of claim 18, wherein said floating platform further comprises a lower surface.

25. The floating fire enclosure of claim 18, further comprising flotation foam.

26. The floating fire enclosure of claim 24, wherein said lower surface has an opening, wherein the distance between the upper surface and lower surface of the floating platform is the height of the platform and said opening is a void spanning the entire height of said platform.

27. The floating fire enclosure of claim 24, wherein the opening on the upper surface of the platform extends to the lower surface of the platform.

28. The floating fire enclosure of claim 24, wherein the circumference of the opening on the upper surface of said platform is substantially the same as the circumference of the opening on the lower surface of said platform.

29. The floating fire enclosure of claim 18, wherein the area of said opening in the upper surface of said platform is up to 40% of the area of the entire upper surface.

30. The floating fire enclosure of claim 18, wherein said support structure is made from iron, metal or aluminum.

31. The floating fire enclosure of claim 18, wherein said enclosure accommodates up to 3200 kilograms on it.

32. A method of making a floating fire enclosure, comprising:
(a) providing a floating platform, wherein said floating platform has an upper and a lower surface;
(b) removing a portion of the upper surface of said floating platform to reveal an opening;
(c) attaching at least one support structure spanning at least a portion of said opening; and
(d) positioning a fire enclosure on said support structure.

33. The method of claim 32, wherein up to 40% of the upper surface is removed.

34. The method of claim 32, wherein said support structure is iron or an iron substitute and is fixed to at least a portion of said opening.

35. The method of claim 32, wherein said positioning step includes mounting, fixing, permanently attaching or clipping.

36. The method of claim 32, further comprising the step of adding floatation foam to the floating fire enclosure.

37. A method for supporting a fire enclosure on a body of water, comprising: inserting a floating platform having an upper surface with an opening thereon into a body of water, wherein at least one support structure spans at least a portion of the opening on the upper surface of said floating platform.
